(19) United States
(12) Patent Application Publication
(10) Pub. No.: US 2013/0266328 A1
(43) Pub. Date: Oct. 10, 2013

(54) QUANTUM ENTANGLEMENT COMMUNICATIONS SYSTEM

(71) Applicant: Marc S. Paller, New York, NY (US)

(72) Inventor: Marc S. Paller, New York, NY (US)

(21) Appl. No.: 13/835,937

(22) Filed: Mar. 15, 2013

Related U.S. Application Data
(60) Provisional application No. 61/620,516, filed on Apr. 5, 2012.

(51) Int. Cl. H04B 10/25

(52) U.S. Cl. CPC H04B 10/25; Y10S 977/774; Y10S 977/742; Y10S 977/96; Y10S 977/842; Y10S 977/882; B82Y 10/00
USPC 398/135; 977/774; 977/742; 977/960; 977/842; 977/882

(57) ABSTRACT

Apparatus for transmitting and receiving information using one or more quantum-entangled particles. The apparatus may include a first substrate including a first row of quantum dots and a second substrate including a second row of quantum dots. The apparatus may also include a beam splitter configured to inject a first particle into a first quantum dot and to inject a second particle into a second quantum dot. A physical property of the first particle may be in a quantum-entangled state with a physical property of the second particle. The apparatus may further include a first wave source configured to move the first particle along the first row of quantum dot, and a second wave source configured to move the second particle along the second row of quantum dots.

### CROSS-REFERENCE TO RELATED APPLICATIONS

This application claims the benefit of U.S. Provisional Application No. 61/620,516, filed Apr. 5, 2012, which is hereby incorporated by reference in its entirety.

### FIELD OF TECHNOLOGY

Aspects of the disclosure relate to apparatus and methods for providing a communications network that utilizes quantum entangled particles for information transmission.

### BACKGROUND OF THE DISCLOSURE

Communication networks today use one or more copper wires, coaxial cables, optical fibers or photons to transmit information. Each of these forms of communication can potentially be blocked, jammed, intercepted, detected and/or interfered with. It would be desirable, therefore, to provide apparatus and methods for a communications system that has a lesser probability of being obstructed by one or more outside forces.

Quantum entangled systems have become recognized for their ability to communicate information without any physical medium. Quantum entanglement occurs when particles such as molecules, electrons, photons, and even small diamonds interact under certain conditions. These particles, after the interaction, are considered to be in an ‘entangled state.’

One characteristic of the quantum-entangled state is that if the entangled particles are separated, a measurement of a physical property of one entangled particle immediately affects the physical property of the other entangled particle. For example, if two electrons become entangled and subsequently separated, a measurement made of the first electron's spin state will automatically affect the spin state of the second electron. In this example, if the electron spin of the first electron was measured to be a clockwise spin, then the spin of the second particle, when measured at a later point in time, will be found to have a counterclockwise spin. This holds true irrespective of when the measurement of the first particle took place.

The creation of entangle particles is discussed in “Carbon Nanotubes as Cooper-Pair Beam Splitters,” L. G. Herrmann et al., Physical Review Letters, Jan. 11, 2010, which is hereby incorporated by reference herein in its entirety.

Transferring entangled electron between two quantum dots is discussed in “On-demand single-electron transfer between distant quantum dots,” P. G. McNeil et al., Nature, Sep. 22, 2011, which is hereby incorporated by reference herein in its entirety.

Manipulating the orientation of an entangled particle is discussed in “Ultrafast optical rotations of electron spins in quantum dots,” A. Greilich et al., Nature Physics, April 2009, which is hereby incorporated by reference herein in its entirety.

However, the need for a communications system using quantum entangled particles for receiving and transmitting information has not been addressed. Therefore, apparatus and methods are provided for communicating using entangled particles as a means for transmitting and/or receiving information.

### BRIEF DESCRIPTION OF THE DRAWINGS

FIG. 1 shows illustrative apparatus in accordance with the systems and methods of the invention;

FIG. 2 shows illustrative apparatus in accordance with the systems and methods of the invention;

FIG. 3 shows illustrative apparatus in accordance with the systems and methods of the invention;

FIG. 4 shows illustrative apparatus in accordance with the systems and methods of the invention;

FIGS. 5A-5C shows illustrative apparatus in accordance with the systems and methods of the invention;

FIG. 6 shows illustrative apparatus in accordance with the systems and methods of the invention;

FIG. 7 shows illustrative apparatus in accordance with the systems and methods of the invention;

FIGS. 8A-8C shows illustrative apparatus in accordance with the systems and methods of the invention; and

FIG. 9 shows illustrative apparatus in accordance with the systems and methods of the invention.

### DETAILED DESCRIPTION OF THE DISCLOSURE

### A. Introduction

The apparatus and methods of the invention relate to a quantum entanglement communications systems. The communications systems may include the ability to create entangled particles, extract the entangled particles, separate the entangled particles from one another physically, change the quantum state of a first particle and detect resultant change in the second particle's quantum state.

### B. Creating, Extracting, and Initially Separating Entangled Particles

The apparatus and methods of the invention may include apparatus for creating, extracting, and initially separating entangled particles. The entangled particles may be molecules, electrons, photons, or any other desirable entangled particle.

The apparatus may include a solid-state circuit. The solid-state circuit may be fabricated on a substrate using electron beam lithography, thin film deposition and/or any other suitable technique. The circuit, when activated, may create entangled electrons. The circuit may subsequently eject the entangled electrons from the material in which the entangled electrons were created.

In exemplary embodiments, the circuit may include a nanotube connected to two thin film metallic electrodes and a central superconducting finger. The electrodes may be normal, or non-superconducting.

In some embodiments, shadow evaporation techniques, or other suitable techniques, may be used to fabricate contacts for the normal and superconducting conductors. The normal contacts may include a few nanometers (nm) of Ti (titanium). In these embodiments, the Ti may enhance film adhesion to the substrate. The normal contacts may additionally or alternatively include a few tens of nanometers of Au (gold) or of Pd (palladium).

The nanotube may be a single wall carbon nanotube (SWNT). The single wall carbon nanotube may be manufactured by chemical vapor deposition. The nanotube may be aligned with the normal electrodes. The nanotube may bridge between the two electrodes and may be in communication with the superconducting electrode.

The nanotube may also include two or more quantum dots. The quantum dots may be engineered in the single wall carbon nanotube. Alternatively, two carbon nanotubes may be fabricated, each nanotube including a quantum dot.

The central superconducting electrode included in the circuit may be used as a source of entangled particles. In some embodiments, the singlet pairing of Cooper pairs in the superconductor may be the source of spin entangled electrons.

It should be noted that the central superconducting electrode may have a width of less than 1 nm to over 200 nm. For example, the width of the superconducting electrode may be 10, 20, 30, 50, 100, 200 nm, or any integer value therebetween. It should additionally be noted that the central superconducting electrode may include an aluminum/palladium bilayer of a width of Al (˜100 nm)/Pd (˜3 nm). The contacts may have resistances as low as a few tens of k′Ω between the normal and superconducting reservoir

The circuit may operate to eject the Cooper pairs from the superconductor. These pairs may be ejected by operating the circuit as a beam splitter. In some embodiments, the circuit may operate as a Cooper-pair beam splitter, to create and eject the entangled electrons, in the form of Cooper pairs, from the superconductor.

For example, in some embodiments, the circuit may be operated by biasing the central superconducting electrode. In such embodiments, a current may flow from the superconducting electrode along the nanotube to the normal electrodes. This may generate an applied bias voltage that may be smaller than the energy gap of the superconductor. This may be the result of Cooper-pair injection. It should be noted that the sub gap current may be enhanced by tuning the circuit to degeneracy points of two quantum dots with the help of capacitively coupled side gate electrodes.

The circuit substrate may include highly doped Si (silicon) substrate. The substrate may include a layer of SiO₂ having a thickness of about ˜500 nm, or any suitable thickness. The layer may operate as a global back gate. The two side gates may have voltages that can be tuned to control the two normal conductors, which may represent two sides (e.g., #1 and #2) relative to the central superconducting electrode of the circuit. The two normal contacts may be separated by a distance of between sub-micrometer and 1 μm, or more.

The circuit may be operated as a series double quantum dots by setting V_{sc}=0 and Vₙ≠0, where “sc” is the superconducting electrode and “n” the normal electrode. The circuit may be operated as a beam splitter by setting V_{sc}≠0 and Vₙ=0. The left and right sides of the circuit may have a differential conductance that may be qualitatively the same dependence as a function of V_{sc}, V_{g1} or V_{gr}, where V_{g1} and V_{gr} are the left and right gate voltages. In some embodiments, cooper pairs may be injected when V_{sc}<85 μV.

It should be noted that a sufficiently large magnetic field (e.g., about 45 mT), may be applied perpendicular to the axis of the superconducting finger. This magnetic field may cause the superconducting portion of the circuit to conduct under normal conduction. This may also cause the beam splitter (to which may be applied a field of ˜90 mT) to operate in a normal state. Such a magnetic field may be used to avoid superconductivity of the Al/Pd film.

### C. Separating a Single Entangled Particle from its Counterpart

The systems and methods of the invention may include separating the entangled electrons from one another. In exemplary embodiments, the separation may be accomplished by moving an individual electron between quantum dots.

A source of electrons may be used to initialize this process. In some embodiments, the beam splitter described above may serve as the source of electrons. In these embodiments, each of the two quantum dots included in the solid-state circuit described in “B” above may be the first quantum dot in the apparatus described below.

An empty compound semiconductor quantum dot, e.g., InAs (indium arsenide), or any other suitable material, may first be populated with an electron. Once populated, the same individual electron may be moved between additional InAs quantum dots as desired.

The apparatus used to transfer the electron(s) between the quantum dots may include a plurality of quantum dots, with adjacent quantum dots being connected by a transport channel.

Negative voltages may be applied to patterned metal surface gates. These negative voltages may facilitate the depletion of a two-dimensional electron gas that exists ˜100 nm below the surface. The applied voltages may be chosen so that the potential of the system may be above E_{f} (Fermi energy).

Each quantum dots may be electronically adjusted by two plungers and barrier gates. Each plunger may raise and lower the corresponding dot. Each barrier may control the degree of energy isolation between a particular dot and the neighboring reservoir. The charge in each quantum dot may be determined by its effect on the electrical conductance of high resistance constrictions on the other side of a narrow separation gate.

A single electron may be initialized in one particular quantum dot and then transferred along the transport channel, when desired, to an adjacent quantum dots using a short duration pulse of surface acoustic waves (“SAWs”). In a piezoelectric material, such as gallium arsenide (GaAs), SAWs create a moving potential modulation. This potential modulation may trap and transport electrons. A second SAW pulse, travelling in the reverse direction, may return the transferred electron giving two-way transfer.

A description of an illustrative quantum dot initialization procedure follows. To set up an occupied quantum dot (QD₁), a barrier gate (BG₁) and a plunger gate (PG₁) are lowered to populate the QD₁. Subsequently, the BG₁ may be elevated, isolating QD₁ from the reservoir. PG₁ may then be elevated to depopulate the dot selectively, leaving one, or more, electrons, as desired. BG₁ and PG₁ may then be adjusted, step-wise, to their terminal voltages. The dot now contains a selected number of electrons held close to, but below, the channel potential. An empty dot may be similarly initialized, but with the plunger gate being elevated first. The terminal voltages for both the empty and occupied quantum dots may be the same, therefore the detector conductance may be indicative of the number of electrons in each dot.

An initialized quantum dot may be depopulated on demand by a brief SAW pulse. Applying a microwave signal to a transducer may generate a SAW. The accompanying potential modulation may move at approximately 3,000 ms⁻¹, capturing the electron from the QD₁ and transferring it in approximately 1.5 ns to the next quantum dot (QD₂). The transfer of charge may be apparent by simultaneous step changes in the detector conductance.

In some embodiments, the SAW amplitude may be, for example, a factor of about 2.5 greater than the electrons amplitude. This may assist in ensuring that a single electron is being transferred between the dots.

It should be noted that, in some embodiments, two transducers may be used to provide for bidirectional transfer between the quantum dots. In these embodiments, single electrons (or pairs) may be sent backwards and forwards in bursts (as in a game of tennis) with “rallies” comprising tens to hundreds of SAW pulses.

For the purposes of transferring an entangled electron between quantum dots, control pulses such as, for example, three SAW₁-SAW₂ pairs, may be first used to show that the system is empty. At a later time, an electron may be loaded into the first quantum dot. The electron may then be sent forth to the next quantum dot by lowering the adjacent quantum barrier and generating a clearing pulse to removes the electron from the channel. This pulse may move the electron into to an adjacent reservoir, such as an adjacent quantum dot circuit.

The source of electrons for the following illustrative transfer method may be the beam splitter described in “B” above. This may be accomplished, in some embodiments, by having both of the carbon nanotube quantum dots being connected to the beginning of a transport channel. A single electron may then travel down each transport channel. This may be in place of, or in addition to, connecting the nanotube quantum dots to their respective electrodes as described above.

SAW pulses, or any other suitable potential, magnetic field, electronic field, electromagnetic field and/or microwave field may then be applied to the electron to pluck the electron from its source and move it along its transport channel. Some embodiments may allow an electron to travel through the carbon nanotube and subsequently enter an electron reservoir at the end of the electrode. At that point the transport channel may begin to move the electron along the channel.

These device elements, for example, with their modifications described above may be run simultaneously, so that the electron beam from the former element may provide the electrons and the latter may then move them into an empty InAs quantum dot. This process may be carried out multiple times.

Two rows of InAs quantum dots heading in opposite directions may be necessary. Each row may have its own transport channel, dimensions and components as described above. Each transport channel may begin at its respective nanotube included in the beam splitter, or at the electron reservoir. Each row may have a sufficient number of InAs quantum dots in order that the separation between the two rows at their opposing ends may be, in the range of sub-centimeter to 5 cm, or more, for example, 1, 2, 3, 4 or 5 centimeters, or any value therebetween, fractional or otherwise. This may ensure that there are a sufficient number of quantum dots, containing entangled electrons, at the opposing ends to create a quantum ensemble at both ends.

When an entangled pair is created by the beam, the pair may be split and travel into one of the two carbon nanotube quantum dots. Each electron may then be moved through its corresponding transport channel to the first InAs quantum dot in its respective row, described above. The channel leading to the first quantum dot may then be closed once the electron reaches the first dot. At this time the electrons are then moved to the next quantum dot, repeatedly, until the electron is placed into the last quantum dot in the row and its gate may be subsequently closed. This process may be repeated until all of the quantum dots in the respective quantum ensembles are populated with individual electrons.

Once the quantum ensembles are full, the substrate/wafer on which the quantum ensembles are deposited may then cut perpendicular to the rows of quantum ensembles, and, in some embodiments, at the start of the two channels. The cutting of the substrate/wafer may create two substrates with each substrate holding one of the two quantum ensembles that contain the entangled electrons. One of the two substrates may be used for transmitting purposes while the other substrate may be used as a receiver.

### D. Illustrative Quantum Transmitter and Receiver

The methods and apparatus of the invention include changing and detecting the spin of electrons in quantum dot ensembles. The spin may be changed by a transmitter. A change in spin may be detected by a receiver. It should be noted that, in some embodiments, the transmitter may be included in a transceiver. It should additionally be noted that, in some embodiments, the receiver may be included in a transceiver.

In illustrative embodiments, a pump beam may be used to change the spin of the electrons, and a probe beam may used to measure the changes caused by the pump beam. The changing may be done on a first ensemble of quantum entangled electrons. The detecting may be done on a second ensemble of electrons. The first ensemble and the second ensemble may be populated with entangled electrons as described in “C” above.

In some embodiments, the pump beam may change the spin of electrons in a first quantum dot ensemble for a period of time necessary for the probe beam to detect the resultant change in the spin of electrons in a second quantum dot ensemble.

In additional illustrative embodiments, a controller may be used to change the spin of the electrons using an electric field, magnetic field, or electromagnetic field, and a detector may be used to measure the changes caused by the controller. The detecting may be done on a first ensemble of quantum entangled electrons. The detecting may be done on a second ensemble of electrons. The first ensemble and the second ensemble may be populated with entangled electrons as described in “C” above.

It should be noted that there are advantages to using a quantum ensemble to transmit data. Specifically, electrons in a quantum state can have random spins, or spins that are influenced by outside forces called Hamiltonians. In order to reduce this error, numerous quantum entangled electrons may be used so that the sum total of all of the quantum entangled electrons the transmitter influences and the sum total of the influences detected by the receiver determines if a signal has been sent or not. The more quantum entangled electrons used to make up the ensemble, the less likelihood that the signal sent by the transmitter will be from a random event. However, in some embodiments, a single electron may be used to transmit data to a receiver. In these embodiments, the receiver may include a second electron that is in a quantum entangled state with the single electron.

### E. Changing the Spin of Entangled Electrons in an Illustrative Quantum Ensemble (Transmitter)

The methods and apparatus of the invention may include changing the spin of one or more entangled electrons. In some embodiments, the ensemble of entangled electron(s) may be included in the substrate/wafer discussed in section “C” above.

Periodic optical laser pulses may initialize, in the z-direction, some arrays of quantum dots (e.g., (In,Ga)As) where each dot typically contains, on average, a single electron spin. The polarization of these spins may be along the direction of the light propagation. This direction may be parallel to the quantum dot direction of growth. Along the x-axis a magnetic field, B, may be applied. Pulsed optical pumping may instantaneously orient the spins along the optical. The laser's electric field, E, may excite a non-homogeneous arrangement of quantum dots with differing dipole moments and transition energies. Spectroscopic responses may be averaged over many dots.

It should be noted that, for optical control on a picosecond timescale, one or more operations, typically between 50 and 150 operations, and in some embodiments, about 100, operations may be performed during the coherence time.

The ellipticity of a probe laser may measure the precession of spins. The precession may be proportional to the spin polarization along the optical axis z, which may be represented by a precession in the y-z plane may represent the spin vector that oscillates about B. To induce rotations of the spins ultrafast control laser pulses may be used.

A device including one or more elements of the devices described above may be used, excluding the probe beam. The pump beam may be used to change the spin of the quantum ensemble electrons, therefore acting as a transmitter.

Transmitter calibration suggests that the probe beam be used in order to collect data on various parameters, including the peak amplitude and its corresponding period when there may be a change.

For a binary transmitting system, considering a change in spin as 1 and no change as 0, the calibration may include transmitting consecutive changes at various time intervals to determine the optimal rest period. This period, in conjunction with the peak amplitude, may be used to determine when a 1 may be transmitted and if there is no peak amplitude, during this period a 0 may be transmitted. This may be performed in conjunction with the receiver to determine if there may be a need to account for any discrepancies.

In a numeric transmitting system, incoming data may be converted using BASE-64 encoding, or similar, into a text string. The text string may be encoded into a number using a similar encoder. The resulting number may be converted into radians between 0 and π. The pumped beam may alter the spin to that specific radian value, thereby increasing the amount of transmitted data, for example, by many orders of magnitude dependent upon the size of the original data.

Although only one such optical embodiment for creating a transmitter is described, there may be other ways to accomplish this including purely electronic methods and hybrid electronic-optical methods.

In exemplary embodiments, the transmitter may consist of a set of magnetic and/or electrical current generating solid state components on opposing sides of the quantum dot ensemble for the purposes of causing the quantum entangled electrons to change their spin state. Because electrons by themselves are charged, applying a magnetic or electrical field of sufficient strength near them can cause them to alter their spin state while allowing the quantum entangled electrons to stay in the quantum state. Electron spin resonance (ESR) is one such method for achieving this, while there are others including superconducting quantum interference devices (SQUIDS), which are all known to those in the field.

### F. Detecting the Spin of Entangled Electrons in an Illustrative Quantum Ensemble (Receiver)

The method of detecting spin entangled electrons described above at “E” may be used. The pump beam may be excluded in an embodiment acting as a receiver, and the probe beam may be used to detect the change in spin of the quantum ensemble electrons.

In some embodiments with a binary receiving system, the calibrated data (above) may be used together with measurements from the probe beam to determine whether a 1 or a 0 was transmitted. In some embodiments, it is preferable that the probe beam acquire measurements, in the range from, at least a fraction, to 10, or more, for example, 2, 3, 4, 5, or 10, or any value therebetween, fractional or otherwise, times faster than the rest period.

In another embodiment of a numeric receiving system, the probe beam may measure a quantity which may be converted into a correlated spin change. The resulting radian value representing the spin change, may be decoded back into a number, then decoded back into a string and decoded back into the data. This may be parallel to a numeric transmitting system in which decoders may be used. Some embodiments may include purely electronic methods and hybrid methods.

Alternatively, the receiver may consist of a set of magnetic and/or electrical solid-state components on opposing sides of the quantum dot ensemble for the purposes of indirectly reading quantum entangled electron changes to their spin state. Because electrons by themselves are charged, measuring the effect of the quantum entangled electrons spin on a magnetic field, or the inducement of one, or its influences on an electrical field or current its charge allows for the indirect measurement of the quantum entangled electron spin states, which permits the quantum entangled electrons to stay in the quantum state. ESR is one such method of achieving this, while other such methods include SQUIDS.

### G. Controlling the Illustrative Quantum Ensemble Transmitter

Data that is to be transmitted may be fed into the controller that controls the pulses of the pump beam, where it may be then converted into appropriate pulses that may be sent to the pump laser in conjunction with the type of transmitting system desired (i.e., binary or numeric), which may transmit the incoming data to the receiver.

In other embodiments, the controller may receive data to be transmitted and subsequently apply one or more magnetic and/or electric fields on a quantum ensemble in conjunction with the type of transmitting system desired (i.e., binary or numeric), which may transmit the incoming data to the receiver.

### H. Controlling the Illustrative Quantum Ensemble Receiver

A controller may pulse the probe beam, based upon the transmitter calibration data, on to the quantum ensemble. In other embodiments, the controller may detect changes in one or more magnetic and/or electric fields, based upon the transmitter calibration data, on the quantum ensemble.

The result of which may be measured, as described above, and sent to a controller that converts the measurement, depending on the type of transmission (i.e., binary or numeric), into a datagram. The controller may stream the datagram to its next destination.

### I. Illustrative Quantum Entanglement Apparatus Embodiments

A. Construction of an Illustrative Solid-State, Uni-Casting, One-Way, Quantum Entanglement Communications Apparatus for Transmission of, One or More, of Voice, Data and Other Suitable Information from One Device to Another.

This illustrative example may include one or more the features of the procedures described in sections B through H, above, or any other suitable procedure or procedures.
aᵢ The resulting transmitter, its lasers and controller may be placed into a new, or replace existing circuitry, that suggests the transmission of voice and/or data in a one-way direction.
aᵢᵢ The resulting receiver, its detector and controller may be placed into new or replace existing circuitry that will receive transmission from its corresponding transmitter.

B. Construction of an Illustrative Solid-State, Uni-Casting, One-Way, Multi-Channel, Quantum Entanglement Communications Apparatus for Transmission of, One or More, of Voice, Data and Other Suitable Information from One Device to Another.

This illustrative example suggests may include one or more the features of the procedures the combination of procedures described in sections B through H, above, or any other suitable procedure or procedures. The steps may be repeated over again for each additional communications channel desired.
bᵢ These other channels may be used for fail-over, redundancy, and/or to further increase throughput.
bᵢᵢ An additional controller, referred to as the master transmitter controller, that incoming voice and data flow pass and may connect to the transmitter's controllers to monitor each of the transmitter's controllers to determine a preferred way to utilize the additional channels. The controller may redirect incoming voice and data flows to the appropriate transmitter or transmitters.
bᵢᵢᵢ The resulting transmitters, their lasers and controller along with the master transmitter controller may be placed into a new, or replace existing, circuitry for the transmission of voice and/or data in a one-way direction.
bᵢᵥ On the receiver side, a master receiver controller may be connected to each detector's controller that may be monitoring their respective quantum ensemble and where the incoming data flows from the detectors may be synchronized and redundant information may be removed before the voice or data digital stream may be sent to the appropriate destination.
bᵥ The resulting receivers, their detectors and controller(s) along with its master receiver controller may be placed into new, or replace, existing circuitry that may receive transmission from its corresponding transmitter.

C. Construction of an Illustrative Solid-State, Uni-Casting, Two-Way, Quantum Entanglement Communications Apparatus for Transmission of, One or More, of Voice, Data and Other Suitable Information from One Device to Another.
cᵢ This illustrative example may include one or more the features of the procedures the combination of procedures described in sections B through H, above, or any other suitable procedure or procedures.
cᵢᵢ This illustrative example may include one or more the features of the procedures the combination of procedures described in sections B through H, above, or any other suitable procedure or procedures.
cᵢᵢᵢ In the first device place the transmitter quantum ensemble substrate/wafer and components from cᵢ and the receiver quantum ensemble substrate/wafer and components from cᵢᵢ.
cᵢᵥ. From step cᵢᵢᵢ (above) a connection between the transmitter's controller and receiver's controller to another controller may be used for additional network overhead commands that may be added to the signal being transmitted by the transmitter.
cᵥ. This transmitter chip and its respective components, as well as this receiver chip with its respective components, along with the other controller may be placed into new, or replace existing, circuitry.
cᵥᵢ. In the second device, place the receiver quantum ensemble substrate/wafer and components from cᵢ and the transmitter quantum ensemble substrate/wafer and components from step cᵢᵢ.
cᵥᵢᵢ. From step cᵥᵢ (above), a connection between the transmitter's controller and receiver's controller to another controller may be used for additional network overhead commands that may be added to the signal being transmitted by the transmitter.
cᵥᵢᵢᵢ. This transmitter chip and its respective components, as well as this receiver chip with its respective components, along with the other controller may be placed into new, or replace existing, circuitry.

D. Construction of a Solid-State, Two-Way, Multi-Channel, Quantum Entanglement Communications Apparatus for Transmission of, One or More, of Voice, Data and Other Suitable Information from One Device to Another.
dᵢ. These other channels may be used for fail-over, redundancy, and/or to further increase throughput.

dᵢᵢ. This suggests the combination of procedures described in B through H, above, but ensuring that the number of quantum transmitting and receiving ensembles may be equal to the number of channels desired.
dᵢᵢᵢ This suggests the combination of procedures described in B through H, above, but ensuring that the number of quantum transmitting and receiving ensembles may be equal to the number of channels desired.
dᵢᵥ. In the first device place the transmitter quantum ensemble substrate/wafer and components from dᵢᵢ (above) and the receiver quantum ensemble substrate/wafer and components from dᵢᵢᵢ (above).
dᵥ. An additional controller, referred to as the master transmitter controller, through which incoming and outgoing voice and data flow pass and may connect to the transmitter's controller to monitor each of the transmitter's controller to determine a preferred way to utilize the additional channels for transmitting and also connects to the receivers controller to determine the most optimal way to utilize the additional receiving channels. The master controller may redirect incoming voice and data flows to the appropriate transmitter or transmitters, which may be based on network overhead commands received from the other transmitter or transmitters.
dᵥᵢ. The resulting transmitters with their components and the receivers with their components, along with a master receiver controller may be placed into new or replace existing circuitry that may receive transmission from its corresponding transmitter.
dᵥᵢᵢ. In the second device place the transmitter quantum ensemble substrate/wafer and components from dᵢᵢᵢ (above) and the receiver quantum ensemble substrate/wafer and components from dᵢᵢ (above).
dᵥᵢᵢᵢ. An additional controller, called the master transmitter controller, through which all incoming and outgoing voice and data flows pass and may connect to each transmitter's controller to monitor each of the transmitter's controller to determine a preferred way to utilize the additional channels for transmitting and also may connect to the receiver's controller to determine a preferred way to utilize the additional receiving channels. The master controller may redirect incoming voice and data flows to the appropriate transmitter or transmitters, which may be based on network overhead commands received from the other transmitter or transmitters.
dᵢₓ. The resulting transmitters with their components and the receivers with their components, along with a master receiver controller may be placed into new, or replace, existing circuitry that may receive transmission from its corresponding transmitter.

### J. Creating an Illustrative Network Based on Quantum Entanglement

E. Construction of an Illustrative Quantum Entanglement Communications Network.
eᵢ. Existing hardware and software may be used to create a network for interconnecting and managing the interconnection of one or more elements of the apparatus described above. The element of the apparatus that may be connected to, and may be part of, the network, and what may be interconnected through the network depends on the specific use of the apparatus. The part could be an apparatus' transmitter, or receiver used in one-way communications or its transmitter and receiver used in two-way communications, all of which may be physically part of the network. This network may be configured to act as a switch, router and/or bridge depending on the intended use of the apparatus, so that voice and data may be sent to any other apparatus that may be connected to this network or through other interconnected networks. There may be one or more networks that may be each connected to each other using one or more of the appropriate apparatus described. There may be no distance limitation to the communications, therefore the interconnected networks may be placed anywhere.
eᵢᵢ. One or more networks may be connected through more traditional connection modalities to other networks to provide access to those networks or systems that do not support quantum entangled connections, and do not want to add one of the described quantum entanglement communication apparatus to their network or networks.

### K. Calibration of the Transmitter and the Receiver

When in use, the transmitter and receiver may be moved separately from each other in three-dimensional space. This may create a need for the transmitter to send a calibration signal to the receiver in order for the receive to recalibrate itself to take into account its positional differences in space to the transmitter.

For example, when the transmitter and receiver are first configured and calibrated they are static in space relative to each other so that the degree of spin change is consistent because the receiver and transmitter are aligned along a spatial plane when calibration occurs. If the receiver is then moved so as to deviate from the original spatial plane that aligned it with the transmitter, spin measurements may be inaccurate in detecting spin change from the transmitter.

Therefore, in some embodiments, a transmitter in accordance with the invention may, from time to time, send a calibration signal to the receiver. This may enable the receiver to make a correct spin measurement irrespective of the spatial position of the receiver to the transmitter.

An exemplary calibration signal may consist of a start made up of 16 up spins and an end made of 16 down spins. Data can only be sent between the start and end. It should be noted that the exemplary calibration signal described above is exemplary only, and any number of spins, in any sequence, may be used as a calibration signal to calibrate the receiver and transmitter described here.

### L. Exemplary Apparatus and Methods According to the Invention

The systems and methods of the invention include apparatus for transmitting and receiving information using one or more quantum-entangled particles. The apparatus may include a first substrate including a first row of quantum dots and a second substrate including a second row of quantum dots. The apparatus may also include a beam splitter configured to inject a first particle into a first quantum dot and to inject a second particle into a second quantum dot. A physical property of the first particle may be in a quantum-entangled state with a physical property of the second particle.

The apparatus may also include a first wave source configured to move the first particle from the first quantum dot into a quantum dot included in the first row of quantum dots, and to move the second particle from the second quantum dot into a quantum dot included in the second row of quantum dots. The apparatus may further include a second wave source configured to move the first particle along the first row of quantum dots, and a third wave source configured to move the second particle along the second row of quantum dots.

The apparatus may additionally include transmitting hardware configured to apply a pulse beam to the first particle to manipulate the physical property of the first particle. The apparatus may further include receiving apparatus configured to apply a probe beam to the second particle to measure the physical property of the second particle.

In some embodiments, the first quantum dot and the second quantum dot may be part of a carbon nanotube. In some embodiments, the beam splitter may be a Cooper-pair beam splitter. In some embodiments, the transmitter may apply the pulse beam using optical laser pulses. In some embodiments, the first particle and the second particle may be electrons and the physical property is may be an electron spin. In some embodiments, the first wave source may use a microwave signal to move the first particle and the second particle.

The systems and methods of the invention may also include apparatus for transmitting and receiving information using one or more quantum-entangled particles. The apparatus may include a wafer. The wafer may include a first substrate including a first row of quantum dots, a second substrate including a second row of quantum dots, and a beam splitter.

The beam splitter may be configured to inject a first particle into a first quantum dot and to inject a second particle into a second quantum dot. It should be noted that a physical property of the first particle may be in a quantum-entangled state with a physical property of the second particle.

The apparatus may also include a first wave source configured to move the first particle from the first quantum dot into a quantum dot included in the first row of quantum dots, and to move the second particle from the second quantum dot into a quantum dot included in the second row of quantum dots. The apparatus may additionally include a second wave source configured to move the first particle along the first row of quantum dots. The apparatus may further include a third wave source configured to move the second particle along the second row of quantum dots.

The apparatus may also include transmitting apparatus. The transmitting apparatus may apply an electric field and a magnetic field to the first particle. The application of the electric field and the magnetic field may alter the physical property of the first particle. The apparatus may additionally include receiving apparatus. The receiving apparatus may detect a change in the physical property of the second particle. The apparatus may further include a detector. The detector may receive a signal from the receiving apparatus.

In some embodiments, the transmitting apparatus may include a first electromagnet located on a first side of the first particle and a second electromagnet located on a second side of the first particle opposite the first side. In some of these embodiments, the transmitting apparatus may apply an electric field to the first particle by applying a voltage to the first electromagnet and the second electromagnet.

In some embodiments, the first particle and the second particle may be electrons and the physical property may be an electron spin.

In some embodiments, the receiving apparatus may detect the change in the electron spin of the second particle using electron spin resonance techniques.

In other embodiments, the receiving apparatus may include a SQUID that includes superconducting wires surrounding the second particle. The SQUID may detect the change in the electron spin of the second particle by detecting a change in an electric field surrounding the second particle.

In some embodiments, the change in the electric field surrounding the second particle may be effected by the altering of the electron spin of the first particle. In some of these embodiments, the signal received by the detector may correspond to the change in the electric field surrounding the second particle.

The systems and methods of the invention may additionally include a method for making a transmitter and a receiver. The method may include fabricating a wafer. The wafer may include a beam splitter. The wafer may also include a first transport channel extending away from the beam splitter and attached to the beginning of a first ensemble of quantum dots. The wafer may further include a second transport channel extending away from the beam splitter and attached to the beginning of a second ensemble of quantum dots.

The method may additionally include generating quantum entangled electrons using the beam splitter and populating the first ensemble of quantum dots and the second ensemble of quantum dots with the quantum entangled electrons. The method may further include cutting the wafer. The cutting may separate the first ensemble of quantum dots from the second ensemble of quantum dots.

The method may also include incorporating the first ensemble into a first electronic device, incorporating the second ensemble into a second electronic device, and using the first ensemble to transmit information from the first electronic device to the second electronic device. The second ensemble may receive the information transmitted by the first ensemble.

In some embodiments, the wafer may be fabricated using e-beam lithography and chemical vapor deposition. In some embodiments, the beam splitter may include a superconductor and the generating may consist of ejecting a Cooper pair of electrons out of the superconductor. In some embodiments, the fabricating may include positioning the end of the first ensemble of quantum dots at a distance at least 2.5 cm away from the end of the second ensemble of quantum dots.

In some embodiments, the first ensemble may transmit information by aligning the spins of the quantum entangled electrons included in the first ensemble along a first direction. In some embodiments, the second ensemble may receive information by detecting the corresponding change in spins of the quantum entangled electrons included in the second ensemble.

The systems and methods of the invention may further include a method of transmitting a binary signal. The method may include generating an electromagnetic signal within a first quantum dot ensemble. The first quantum dot ensemble may include a first plurality of quantum entangled electrons. Each of the first plurality of quantum entangled electrons may be confined within a quantum dot. The electromagnetic signal generated may align the spin of each of the first plurality of quantum entangled electrons in a first direction.

The method may also include reading a signal generated by a second quantum dot ensemble. The second quantum dot ensemble may include a second plurality of quantum entangled electrons. Each of the second plurality of quantum entangled electrons may be confined within a quantum dot. The signal may be generated by an alignment of the spins of the quantum entangled electrons in a second direction. The method may additionally include outputting to a processor the binary value 1 or 0 based on the reading of the signal generated by the second quantum dot ensemble.

In some embodiments, each of the first plurality of quantum entangled electrons may be in a quantum entangled state with one of the second plurality of quantum entangled electrons. In some embodiments, the signal generated by the alignment of the spins in the second direction may correspond to the binary value 1 or 0.

In some embodiments, the generating of the electromagnetic signal may be effected using a microwave generator and two electrically charged walls. The first electrically charged wall may have a positive value. The second electrically charged wall may have a negative value. In some embodiments, the first electrically charged wall may be located on a first side of the plurality of first quantum dots. The second electrically charged wall may be located on a second side of the plurality of first quantum dots opposite the first side.

The system and methods of the invention may further include a transmitter. The transmitter may transmit data by aligning spins of quantum entangled electrons. The transmitter may be part of a cellular phone, a computer, or any other suitable electronic device.

In some embodiments, the transmitter may align the spins of the quantum entangled electrons by generating an electromagnetic signal proximal to the quantum entangled electrons. In some embodiments, each of the quantum entangled electrons may be confined within a quantum dot.

In some embodiments, the quantum entangled electrons may be included in a first quantum ensemble. Additionally, each of the quantum entangled electrons included in the first quantum ensemble may be in an entangled state with an electron included in a second quantum ensemble.

The systems and methods of the invention may further include a receiver. The receiver may be configured to receive data by detecting a field generated by a change in spin of a quantum entangled electron.

In some embodiments, the receiver may detect the field using a superconducting wire that surrounds the quantum entangled electron.

In some embodiments, the quantum entangled electron may be a first quantum entangled electron. In these embodiments, a change in spin of the first quantum entangled electron may be induced by a change in spin of a second quantum entangled electron. The spin of the first quantum entangled electron may be in a quantum entangled state with the spin of the second quantum entangled electron.

In some embodiments, the data received by the receiver may correspond to one of the binary values 1 and 0. In some embodiments, the receiver may output to a processor the binary value 1 or 0.

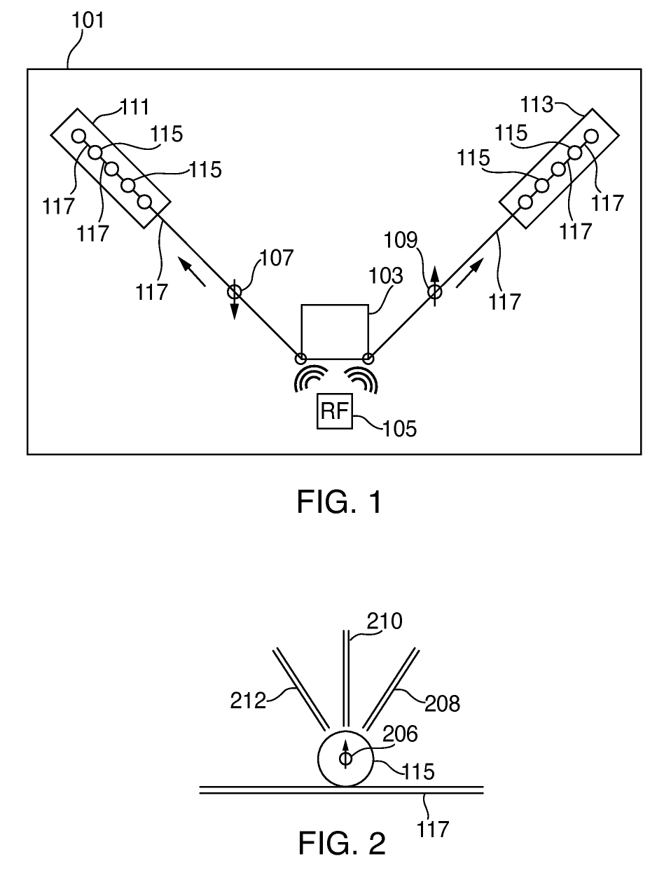

Illustrative embodiments of the systems and methods of the invention may include one or more features illustrated in FIGS. 1-10 described below. FIGS. 1-10 are for illustrative purposes only, and do not in any way limit the scope of the invention. Additionally, one or more features included in FIGS. 1-10 may be added, deleted or modified in accordance with the invention described herein.

FIG. 1 shows illustrative wafer 101 in accordance with the invention. Wafer 101 may be fabricated using thin film deposition techniques, e-beam lithography, chemical vapor deposition and/or any other suitable method.

Wafer 101 may include beam splitter 103, microwave generator 105 and transport channels 117. Wafer 101 may also include electron 107 and electron 109, in addition to quantum dots 115, first substrate 111 and second substrate 115.

Beam splitter 103 may include a superconducting electrode, a carbon nanotube with two quantum dots, and one or more normal electrodes (not shown). It should be noted that beam splitter 103 may include one or more of the apparatus included in the solid state circuit described in “B” above.

Beam splitter 103 may inject a pair of entangled electrons, comprising of electron 107 and electron 109, into the carbon nanotube quantum dots (not shown). Microwave generator 105 may use one or more microwaves to push electron 107 and electron 109 out of the carbon nanotube quantum dots and move them along transport channel 117. Electron 107 may be pushed along transport channel 117 and into a quantum dot 115 located at the beginning of first substrate 111. Electron 109 may be pushed along transport channel 117 and into a quantum dot 115 located at the beginning of second substrate 113.

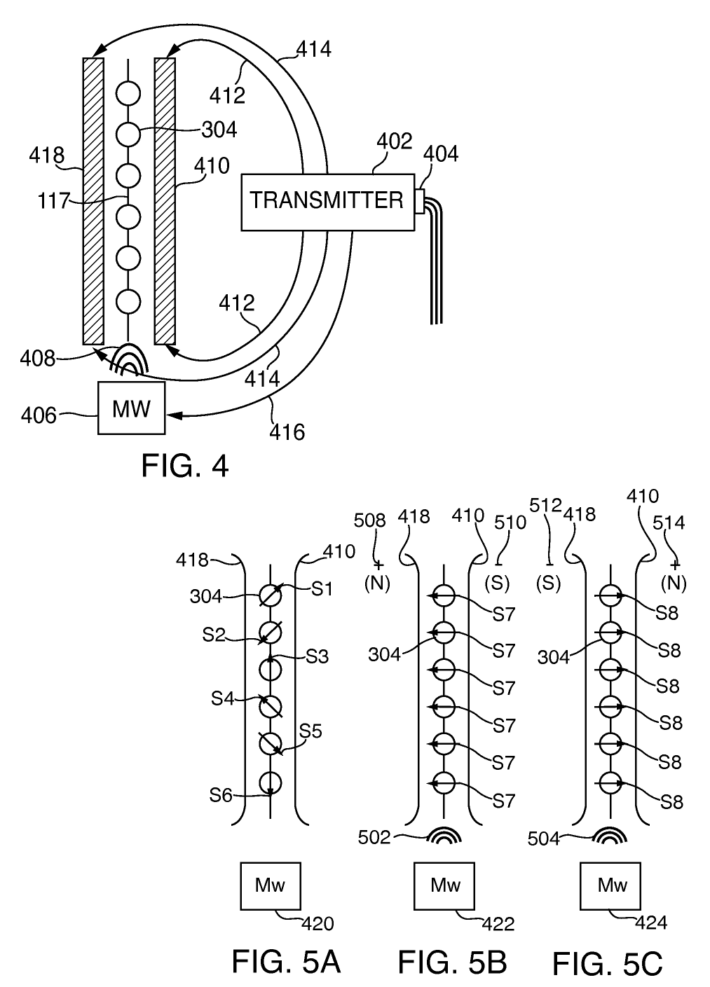

Each of first substrate 111 and second substrate 113 may include a plurality of quantum dots 115 connected by a transport channel 117. In addition to quantum dots 115 and transport channels 117, first substrate 111 may include one or more of the apparatus illustrated in FIG. 4. Additionally, second substrate 113 may include one or more of the apparatus illustrated in FIG. 7.

Wafer 101 may be fabricated with substrates 111 and 113 heading in opposite directions. This may be advantageous when cutting wafer 101, as described in more detail below.

It should be noted that, in some embodiments, the portion of transport channel 117 located between beam splitter 103 and substrates 111 and 113 may include one or more quantum dots (not shown). In these embodiments, microwave generator 105 may move an entangled electron out of the carbon nanotube quantum dot, along transport channel 117, through the quantum dots included in transport channel 117, and finally into one of substrates 111 or 113.

FIG. 2 shows an illustrative transport system in accordance with the systems and methods of the invention. The illustrative transport system may include transport channel 117 and quantum dot 115. The illustrative transport system may also include plunger 210, barrier 208 and central gate 212. In FIG. 2, quantum dot 115 is populated with electron 206. Electron 206 may be a quantum-entangled electron that was ejected from beam splitter 103 illustrated in FIG. 1.

Plunger 210, barrier 208 and central gate 212 may be used to assist in electron localization and transmission along transport channel 117 as described in “C” above.

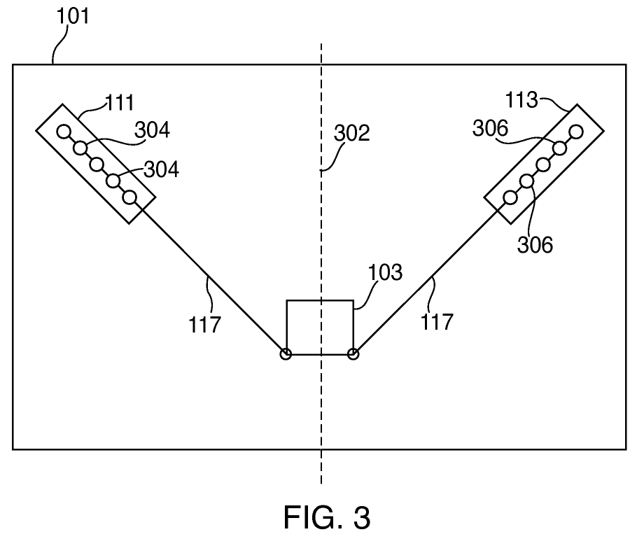

FIG. 3 shows an illustrative method for cutting wafer 101 into two pieces. In FIG. 3, wafer 101 is cut along line 302 to create two separate pieces.

In FIG. 3, first substrate 111 may include populated quantum dots 304. A populated quantum dot 304 may be a quantum dot that contains an entangled electron. Additionally, in FIG. 3, second substrate 113 may include populated quantum dots 306. A populated quantum dot 306 may be a quantum dot that contains an entangled electron. Preferably, wafer 101 is cut only after each quantum dot included on first substrate 111 and second substrate 113 has been populated.

Any suitable apparatus may be used to cut wafer 101. For example, a diamond saw may be used to cut wafer 101 along line 302. It should be noted that the apparatus used to cut wafer 101 may have a width. Because of the width of the cutting apparatus, the separation of substrate 111 from substrate 113 may assist in ensuring that substrates 111 and 113 are not damaged during the cutting.

Alternative embodiments of the invention include cutting wafer 101 in into any suitable shape. For example, in some embodiments, two or more cuts may be applied to wafer 101 in any suitable direction.

Subsequent to the cutting of the wafer, one half of the wafer may be incorporated into apparatus such as a semiconducting body, hooked up to one or more wires, and subsequently be used to transmit information. The other half of the wafer may be incorporated into a second apparatus, hooked up to one or more wires, and subsequently be used to receive information.

It should be noted that the two halves of the wafer may be incorporated into any apparatus that transmits and/or receives information. For example, a quantum ensemble according to the invention may be incorporated into a cell phone, phone, computer, walkie talkie, or any other suitable communication system.

FIG. 4 shows a portion of an illustrative transmitting system according to the systems and methods of the invention. It should be noted that, in some embodiments, FIG. 4 may be a detailed view of substrate 111.

The illustrative transmitting system may include transmitter 402. Transmitter 402 may receive information from data input 404. In response to the information received from data input 404, transmitter 402 may transmit one or more signals to microwave generator 406, component 410 and/or component 418.

Transmitter 402 may transmit a signal to microwave generator 406 using transmission medium 416. Transmitter 402 may transmit a signal to component 410 using transmission medium 412. Transmitter 401 may transmit a signal to component 418 using transmission medium 414.

Each of transmission mediums 412, 414 and 418 may be connectors such as wires. Transmission medium 416 may be used to turn on microwave generator 406. Transmission mediums 412 and 414 may be used to apply a voltage to components 410 and 418.

A signal sent to microwave generator 406 may initiate microwave generator 406 to generate microwave 408. It should be noted that the signal transmitted to microwave generator 406 may determine both the wavelength and the frequency of microwave 408.

A signal sent to one of components 410 and 418 may cause the component to take on a charge, and/or generate a magnetic and/or an electrical field. Component 410 and 418 may be any component that is able to generate a field. For example, component 410 and 418 may be metal plates, electromagnets or wires.

In some embodiments, components 410 and 418 may use electron spin resonance (ESR) or superconducting quantum interference devices (SQUIDS) to generate an electric field.

The generation of a field by one or both of components 410 and 418 may cause the spin of all of the quantum entangled electrons confined in quantum dots 304 to align in the same direction. This effect is demonstrated in greater detail at FIGS. 5A, 5B and 5C below.

It should be noted that, although FIG. 4 illustrates apparatus for using electrical and/or magnetic fields to align the spin of entangled electrons, other apparatus such as lasers can be used to manipulate the electron spin, as detailed in “E” above.

FIG. 5A shows a portion of an illustrative transmission system in accordance with the systems and methods of the invention. The portion of the illustrative transmission system illustrated in FIG. 5A may include six populated quantum dots 304, microwave generator 420, component 410 and component 418. In FIG. 5A, microwave transmitter 420 is not generating any microwave signals. Additionally, components 410 and 4108 are not generating a magnetic or an electrical current. As a result, the spins S1, S2, S3, S4, S5 and S6, of each quantum dot 304 are different and do not exhibit any uniformity. It follows that no information is being transmitted by the illustrative transmission system.

FIG. 5B shows a portion of an illustrative transmission system according to the systems and methods of the invention. The portion of the illustrative transmission system may include six populated quantum dots 304, microwave generator 420, component 410 and component 418. In FIG. 5B, microwave transmitter 422 is generating microwave signal 502. Additionally, component 410 has a negative electric charge, and component 410 has a positive electric charge. The net effect of the magnetic field generated by microwave transmitter 422, and the electric field generated by components 410 and 418, is the alignment of the spin of the electron included in each quantum dot 304 along the direction S7.

It should be noted that, in an exemplary communications system according to the invention, the alignment of the spin of the electrons included in quantum dots 304 along the direction of S7 may be used by a communications system according to the invention a way to transmit the binary bit ‘0’ to a receiver.

FIG. 5C shows a portion of an illustrative transmitting system according to the systems and methods of the invention. The portion of the illustrative transmission system may include six populated quantum dots 304, microwave generator 420, component 410 and component 418. In FIG. 5C, microwave transmitter 424 is generating microwave signal 504. Additionally, component 410 has a positive charge and component 418 has a negative charge.

The net effect of the magnetic field generated by microwave transmitter 422, and the electronic field generated by components 410 and 418, is the alignment of the spins of the electrons in each quantum dot 304 along the direction S8.

It should be noted that, in an exemplary communications system according to the invention, the alignment of an electron with the illustrated spin S8 may be used by a communications system according to the invention a way to transmit the binary bit ‘1’ to a receiver.

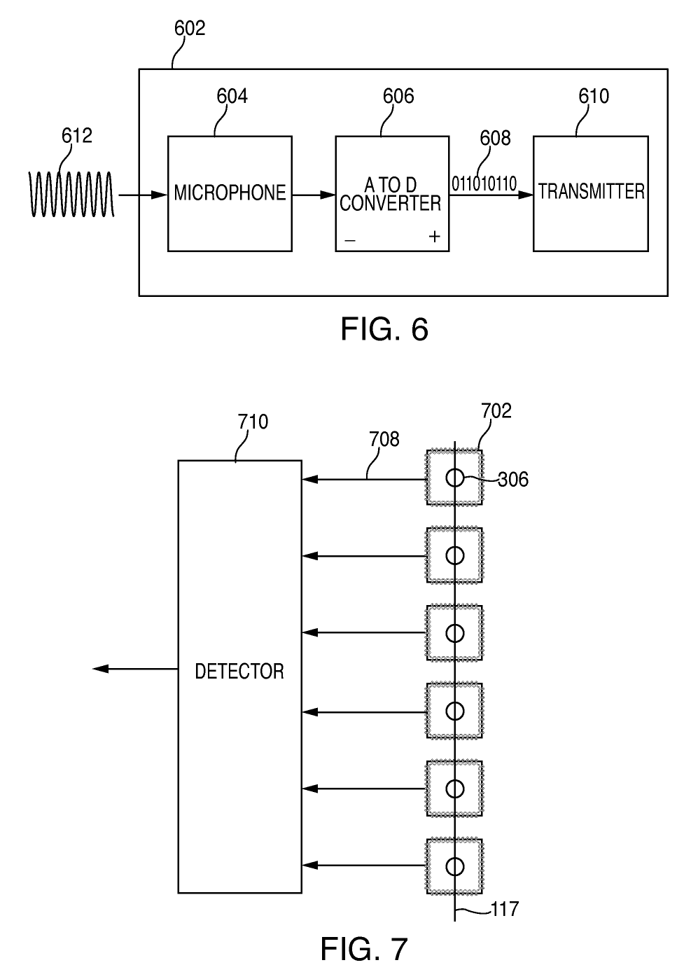

FIG. 6 shows illustrative apparatus 602 that incorporates a transmitter according to the invention. Illustrative apparatus 602 may be a portion of a computer, phone, cell phone, or any other apparatus that receives an input signal and subsequently transmits the signal to a receiver.

In FIG. 6, sound wave 612 is received by microphone 604. Microphone 604 transmits sound wave 612 to Analog to Digital Converter 606. Analog to Digital Converter 606 converts sound wave 612 into digital signal 608. Analog to Digital Converter 606 then transmits digital signal 608 to transmitter 610. Transmitter 610 then transmits each bit received from the digital signal by manipulating the spin of a group of entangled electrons into one of two predetermined directions.

For example, transmitter 610 may transmit a ‘0’ by applying a first electromagnetic field to the group of entangled electrons, aligning the spin of the electrons in a first direction. Transmitter 610 may transmit a ‘1’ by applying a second electromagnetic field to the group of electrons, aligning the spin of the electrons in a second direction.

FIG. 7 shows a portion of an illustrative receiving system according to the systems and methods of the invention. It should be noted that, in some embodiments, FIG. 7 may be a detailed view of substrate 113.

The receiving system illustrated in FIG. 7 may include detector 710 and channels 708. The receiving system may also include quantum dots 306, spin detectors 702, and electron transport channel 117.

Each of spin detectors 702 may include apparatus that enables detector 710 to detect the spin of an electron included in the quantum dot 306. For example, spin detector 702 may consist of a set of magnetic and/or electrical solid state components located on opposing sides of a quantum dot. Alternatively the solid state components may circumscribe the quantum dot. The solid state components may also, or alternatively, enclose the quantum dot on four sides, or completely surrounds the quantum dot. This configuration may enable spin detector 702 to indirectly read any change to the spin of the enclosed quantum entangled electrons.

Exemplary apparatus for indirectly reading a change to an electron's spin state includes ESR, SQUIDS, and any other suitable method. For example, in some embodiments that use SQUIDS to read a change in an electron's spin state, the apparatus may include superconducting wires that surround each quantum dot 306. In these embodiments, if the electron spin changes, the wire may detect a change in an electrical or electromagnetic field. This change in field may induce a current in the superconducting wire, which is then transmitted to detector 710.

Each of spin detectors 702 may feed an electrical signal into channel 708. The signal fed into channel 708 may correspond to the spin of an electron surrounded by spin detector 702. Detector 710 may receive the signals from channels 708. Detector 710 may use the signals to identify the spins of the electrons contained in the populated quantum dots 306.

It should be noted that, although FIG. 7 illustrates apparatus for using electrical and/or magnetic fields to detect the change in spin of entangled electrons, other apparatus such as lasers can be used to manipulate the electron spin, as detailed in “E” above.

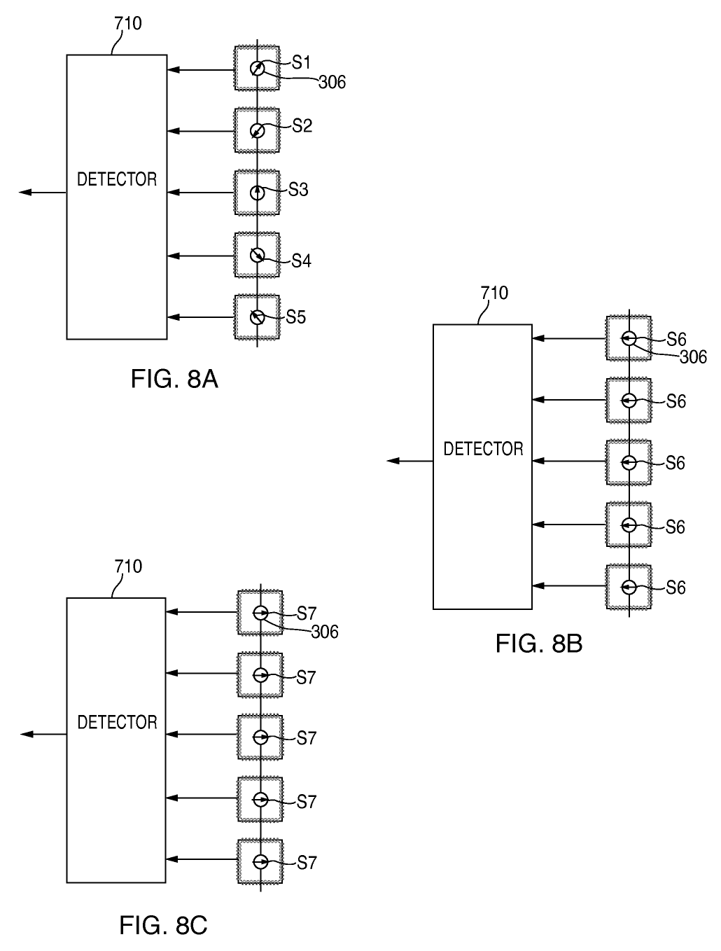

FIG. 8A shows detector 710 and the spins of the electrons included in quantum dots 306. In FIG. 8A, the electron spins of the quantum entangled electrons are S1, S2, S3, S4 and S5, each spin being different from the next. In an exemplary communications system according to the invention, the signal generated by spins S1, S2, S3, S4 and S5 may be equivalent to a ‘no data is being transferred’ signal, or a lack of signal.

FIG. 8B shows detector 710 and the spins of the quantum entangled electrons included in quantum dots 306. In FIG. 8B, each of the quantum entangled electrons have the spin S6. In an exemplary communications system according to the invention, the field generated by five spins S6 may result in the transmission of a signal to detector 710 that is read by detector 710 as an input of the binary value ‘0.’

The alignment of the spin of the electrons in FIG. 8B is a direct result of the alignment of the electrons in FIG. 5C. This is because each electron illustrated in FIG. 5C is in a quantum entangled state with one of the electrons illustrated in FIG. 8B. As a result, the manipulation of the spin of the electrons in FIG. 5C, using electronic and magnetic fields, results in the spins of the electrons in FIG. 8B taking on the spin correlated to the spin of the electrons in FIG. 5C.

FIG. 8C shows detector 710 and the spins of the quantum entangled electrons included in quantum dots 306. In FIG. 8C, each of the quantum entangled electrons have the spin S7. In an exemplary communications system according to the invention, the field generated by five spins S7 may result in the transmission of a signal to detector 710 that is read by detector 710 as an input of the binary value ‘1.’

It should be noted that the alignment of the spin of the electrons in FIG. 8C is a direct result of the alignment of the electrons in FIG. 5C. This is because each electron illustrated in FIG. 5C is in a quantum entangled state with one of the electrons illustrated in FIG. 8C. As a result, the manipulation of the spin of the electrons in FIG. 5C, using electronic and magnetic fields, results in a corresponding manipulation of the spins of the electrons in FIG. 8C.

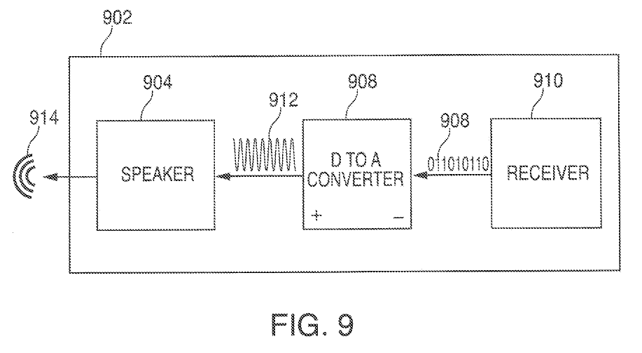

FIG. 9 shows illustrative apparatus 902 that may be used as a receiver in one or more electronic devices. Apparatus 902 may be incorporated into any suitable electronic device, such as a computer, phone, cell phone, or any other apparatus that receives and transmits a signal.

In FIG. 9, receiver 910 may be a receiver in accordance with the invention. Receiver 910 may receive signals that correlate to the spins of a group of quantum entangled electrons. Receiver 910 may process the received signals and transform them into binary output 908. Receiver 910 may transfer binary output 908 to a Digital to Analog Converter 908. Digital to Analog Converter 908 may generate analog signal 912 from binary output 908 and transmit analog signal 912 to speaker 904. Speaker 904 may use analog signal 912 to output sound 914.

Additional apparatus in accordance with the invention may include one or more of the apparatus illustrated in both FIG. 6 and FIG. 9. Any electronic device that requires transmitting may incorporate such apparatus.

In some embodiments, the systems and methods may include transmitting data based on the orientation of an electron's spin, as described above. In these embodiments, the transmitter may use optical methods, or electrical and/or magnetic fields to force the spin of the quantum entangled electrons in a certain direction. The receiver may receive data that corresponds to the orientation of the spins of the electrons. For example, the data received may include the arc surface orientation of the spins using first and second orthogonal angular values such as theta and phi. In these embodiments, a much larger volume of data transmission may be possible with each spin manipulation. For example, each value of theta and phi may range from −180 to 180 and may be evaluated to be a value in that range. The value may have any suitable size, such as fractions of a degree of arc, a degree of arc, two degrees of arc, 5, 10, 20, 30, 45, 60 or any other suitable size.

Additionally, it should be noted that substrates 111 and 113 may include any suitable number of populated quantum dots, in the order of tens, hundreds, thousands, or even tens of thousands of electrons. In these embodiments, a plurality of portions of each substrate may be used to send or receive data. For example, substrate 111 may include three hundred populated quantum dots. A block of thirty populated quantum dots, for example, may be used to transmit a single signal. As a result, each block of quantum dots may be manipulated/detected separately. This may enable multiple pieces of data to be transmitted simultaneously, or substantially simultaneously. Alternately, each block of quantum dots may be manipulated/detected upon the lapse of a predetermined time period.

Thus, methods and apparatus for transmitting and receiving data using quantum entangled electrons have been provided. Persons skilled in the art will appreciate that the present invention can be practiced in embodiments other than the described embodiments, which are presented for purposes of illustration rather than of limitation, and that the present invention is limited only by the claims that follow.

What is claimed is:

1. Apparatus for transmitting and receiving information using one or more quantum-entangled particles, the apparatus comprising:
a first substrate including a first row of quantum dots and a second substrate including a second row of quantum dots;
a beam splitter configured to inject a first particle into a first quantum dot and a second particle into a second quantum dot, wherein a physical property of the first particle is in a quantum-entangled state with a physical property of the second particle;
a first wave source configured to move the first particle from the first quantum dot into a quantum dot in the first row of quantum dots, and to move the second particle from the second quantum dot into a quantum dot in the second row of quantum dots;
a second wave source configured to move the first particle along the first row of quantum dots; and
a third wave source configured to move the second particle along the second row of quantum dots.

2. The apparatus of claim 1 wherein the first quantum dot and the second quantum dot are part of a carbon nanotube.

3. The apparatus of claim 1 wherein the first particle is a first electron, the second particle is a second electron, and the physical property is a spin.

4. The apparatus of claim 1 wherein the first wave source comprises a microwave signal.

5. The apparatus of claim 1 further comprising:
transmitting hardware configured to apply a pulse beam to the first particle to manipulate the physical property of the first particle; and
receiving hardware configured to apply a probe beam to the second particle to measure the physical property of the second particle.

6. The apparatus of claim 5 wherein the transmitter applies the pulse beam using optical laser pulses.

7. The apparatus of claim 3 further comprising:
transmitting apparatus configured to apply a field to the first electron, wherein the application of the field alters the spin of the first electron; and
receiving apparatus configured to detect a change in the spin of the second electron.

8. The apparatus of claim 7 wherein the transmitting apparatus comprises:
a first electromagnet located on a first side of the first electron; and
a second electromagnet located on a second side of the first electron opposite the first side,
wherein:
the transmitting apparatus is configured to apply a field to the first electron by applying a voltage to the first electromagnet and the second electromagnet.

9. The apparatus of claim 7 wherein the receiving apparatus comprises a superconducting quantum interference device “SQUID” that includes superconducting wires configured to circumscribe the second electron.

10. The apparatus of claim 9 wherein:
the SQUID is configured to detect the change in the spin of the second electron by detecting a change in an electric field surrounding the second electron; and
the change in the electric field surrounding the second electron is effected by the altering of the spin of the first electron.

11. A method for making a transmitter and a receiver, the method comprising:
fabricating a wafer including a beam splitter, a first transport channel extending away from the beam splitter and attached to a beginning of a first ensemble of quantum dots, and a second transport channel extending away from the beam splitter and attached to a beginning of a second ensemble of quantum dots;
generating quantum entangled electrons using the beam splitter;
populating the first ensemble of quantum dots and the second ensemble of quantum dots with the quantum entangled electrons; and
cutting the wafer, wherein the cutting separates the first ensemble of quantum dots from the second ensemble of quantum dots.

12. The method of claim 11 wherein the beam splitter includes a superconductor and the generating includes ejecting a Cooper pair from the superconductor.

13. The method of claim 11 further comprising incorporating the first ensemble into a first electronic device and incorporating the second ensemble into a second electronic device.

14. The method of claim 13 further comprising using the first ensemble to transmit information from the first electronic device to the second electronic device, and using the second ensemble to receive the transmitted information.

15. The method of claim 14 wherein:
the first ensemble transmits information by aligning the spins of the quantum entangled electrons included in the first ensemble along a first direction; and
the second ensemble receives information by detecting the corresponding change in spins of the quantum entangled electrons included in the second ensemble.

16. The method of claim 11 wherein the fabricating further includes positioning the end of the first ensemble of quantum dots at a distance at least 2.5 cm away from the end of the second ensemble of quantum dots.

17. A transmitter configured to transmit data by aligning spins of quantum entangled electrons.

18. The transmitter of claim 17 wherein the transmitter is part of a cellular phone or a computer.

19. The transmitter of claim 17 wherein the transmitter aligns the spins of the quantum entangled electrons by generating an electromagnetic signal proximal to the quantum entangled electrons.

20. The transmitter of claim 17 wherein each of the quantum entangled electrons are confined within a quantum dot.

21. The transmitter of claim 20 wherein:
the quantum entangled electrons are included in a first quantum ensemble; and
each of the quantum entangled electrons included in the first quantum ensemble are in an entangled state with an electron included in a second quantum ensemble.

22. A receiver configured to receive data by detecting a field generated by a change in spin of a quantum entangled electron.

23. The receiver of claim 22 wherein the field is detected by a superconducting wire that surrounds the quantum entangled electron.

24. The receiver of claim 22, the quantum entangled electron being a first quantum entangled electron, wherein the change in spin of the first quantum entangled electron is induced by a change in spin of a second quantum entangled electron, wherein the spin of the first quantum entangled electron is in a quantum entangled state with the spin of the second quantum entangled electron.

25. The receiver of claim 22 wherein the data received by the receiver corresponds to one of the binary values 1 and 0.

26. The receiver of claim 25 wherein the receiver is configured to output to a processor the one of the binary values 1 and 0.
